(19) United States
(12) Patent Application Publication
(10) Pub. No.: US 2002/0195787 A1
(43) Pub. Date: Dec. 26, 2002

(54) Childs ride-on treadle scooter

(76) Inventor: Manfred W. Tuch, Palm Coast, FL (US)

Correspondence Address: Manfred W. Tuch, 20 Prince John Lane, Palm Coast, FL, 32164, US

(21) Appl. No.: 09/887,140

(22) Filed: Jun. 25, 2001

(51) Int. Cl. B62M 1/00

(52) U.S. Cl. 280/87.041; 280/87.021

(57) ABSTRACT

A stand on riding two wheeled scooter with handle-bar steering through a rotatable front fork with attached wheel mounted on a platform with the stationary fork rear wheel being driven through an attached sprocket by means of a geared treadle.

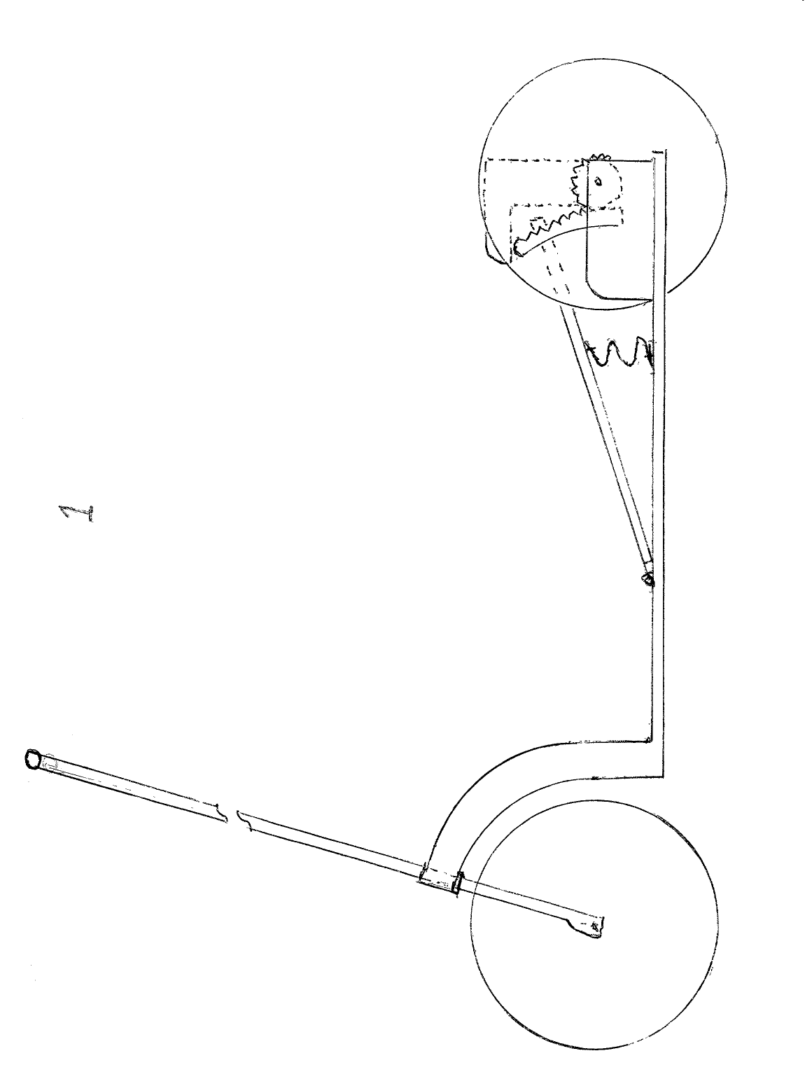

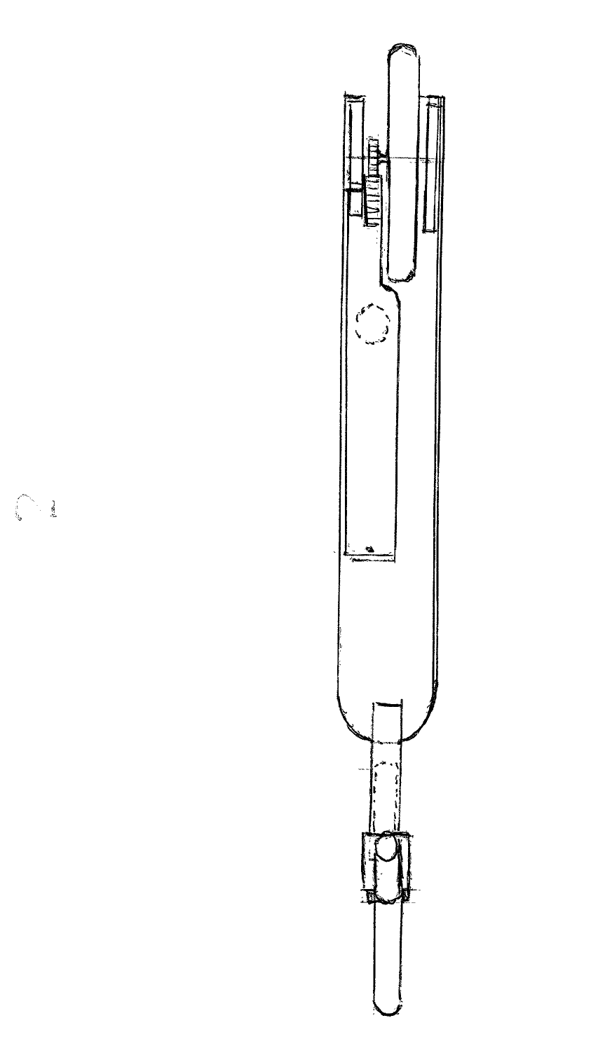

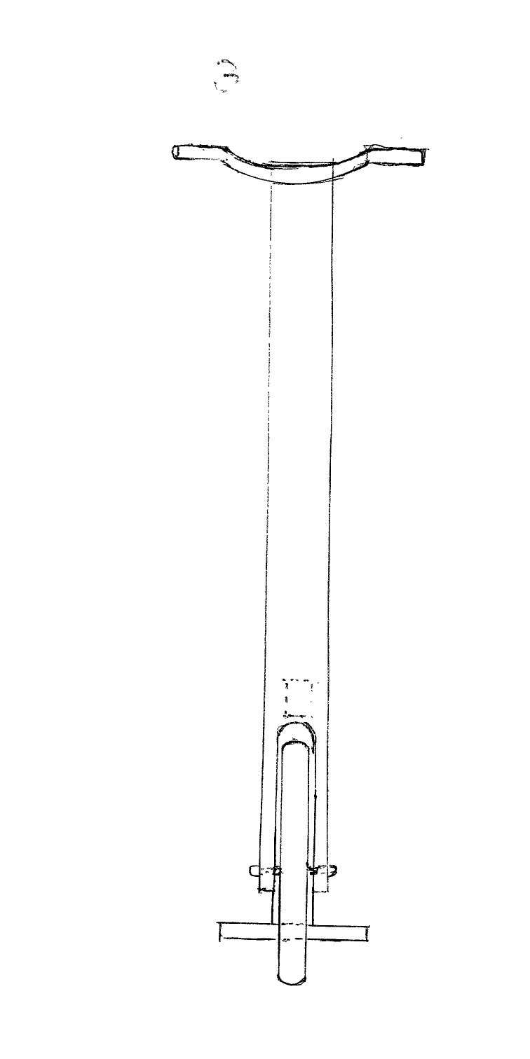

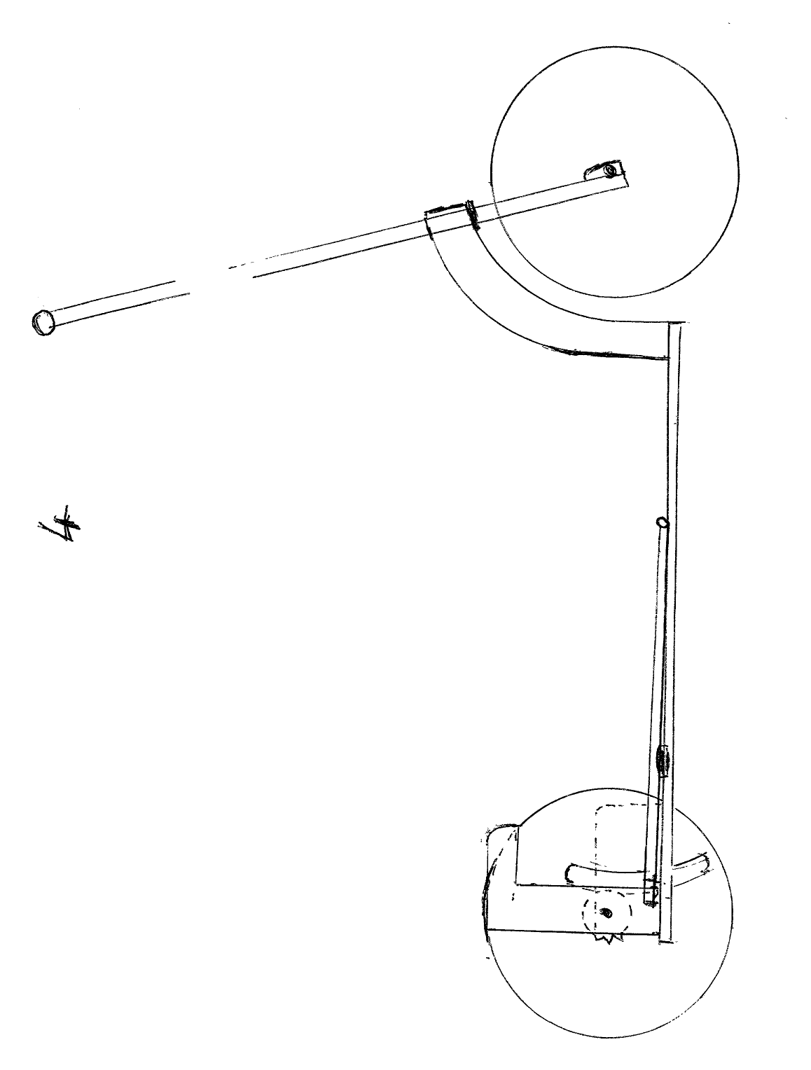

### BACKGROUND

A child's scooter is usually pushed along by having one foot on the platform and with the other foot doing a walking motion on the ground to gain momentum. With the treadle scooter a child has both feet safely on the scooter, one on the platform and one on the treadle. The gear on the treadle engages the sprocket on the rear and forces the real wheel to turn, thereby moving the treadle scooter along. Steering is done with the handle-bar mounted on the front wheel fork extension.

### BRIEF SUMMARY

After watching some of my twelve grand-children getting their feet bloody (doing scooters barefoot) and going through a fair amount of toes of their sneakers, I remembered my mother's old sewing machine with a treadle. I went to my shop and build safer scooter for everybody. By being able to keep both feet on the platform and treadle of the treadle scooter. Also save a lot of shoes.

### BRIEF DESCRIPTION OF DRAWINGS

#1: Side-view of treadle scooter (left side with treadle up).

#2: Top-view of treadle scooter.

#3: Front view of treadle scooter.

#4: Side-view of treadle scooter (right side with treadle down).

### DETAILED DESCRIPTION

A two wheeled stand on children's ride-on toy with the front wheel on a fixed axle mounted to a fork, which in turn is mounted to a rotable extension to a handle-bar to hold on to plus steer the toy. The front fork assembly is attached to a stand on platform which has a offset treadle mounted on it to propel the toy by means of an attached gear. The gear turns the sprocket that is attached to the rear wheel much like a bicycle rear wheel. The rear wheel is attached to the platform with an axle. The down ward force of the foot operated treadle turns the rear wheel and propels the scooter. When the foot pressure is released a return spring returns the treadle to the up position to be able to repeat the propelling down stroke. If the rider does not move the treadle the rear wheel free-wheels if the treadle is up or down. This allows the rider to keep Both feet on the treadle scooter at all times.

1. A child's ride on toy comprised of a two wheeled platform where the front wheel is mounted on a steerable fork and the rear wheel equipped with a sprocket on a stationary fork. A treadle mounted on the platform has a gear attached which drives the sprocket on the rear wheel, thereby propelling the scooter when the treadle is moved up and down. The down motion is done by rocking the foot down, the up motion is done with a return spring when the pressure is released on the treadle. Much like the rocking motion on a antique sewing machine.
